(19) United States
(12) Patent Application Publication
(10) Pub. No.: US 2023/0102096 A1
(43) Pub. Date: Mar. 30, 2023

(54) MULTIFUNCTIONAL RECOGNITION DEVICE AND RECOGNITION SYSTEM USING THE SAME

(71) Applicant: Hak Soo KIM, SAN DIEGO, CA (US)

(72) Inventor: Hak Soo KIM, SAN DIEGO, CA (US)

(21) Appl. No.: 17/951,846

(22) Filed: Sep. 23, 2022

(30) Foreign Application Priority Data
Sep. 27, 2021 (KR) 10-2021-0127315

(51) Int. Cl. H04N 5/232; H04N 5/225; H04N 7/01; H04N 7/18; G06K 7/14

(52) U.S. Cl. CPC H04N 5/23245; H04N 5/2252; H04N 5/2256; H04N 7/01; H04N 7/183; G06K 7/1443

(57) ABSTRACT

A multifunctional recognition device includes: a housing formed on one side thereof with an opening; a recognition section disposed on an inner side of the housing to face the opening to recognize an image of a recognition target or a barcode provided on one side of the recognition target; an information processing section provided on the inner side of the housing to be connected to the recognition section to store and analyze recognition information recognized by the recognition section; a switching section provided on one side of the housing to be connected to the information processing section to switch a setting of the recognition section to a barcode recognition mode or an image capture mode; and a communication section configured to transmit the information stored and analyzed by the information processing section to an outside.

### BACKGROUND OF THE INVENTION

### 1. Field of the Invention

The present invention relates to a multifunctional recognition device and a recognition system using the same, and more specifically, to a multifunctional recognition device and a recognition system using the same, in which the multifunctional recognition device is provided with an image sensor and a barcode scanner, respectively, and simultaneously serves as the image scanner and the barcode scanner in one device without a need to selectively use any device according to a recognition target corresponding to each situation, such that user convenience may be maximized, each information may be stored separately, and the information may be transmitted to the outside.

### 2. Description of the Related Art

In general, a social security number card, a driver's license, a welfare card, and a merit card are used as identification cards for each purpose of issuance.

As an identification card recognizer, which automatically recognizes such identification cards, various devices for checking the identification cards presented by a user have been disclosed.

A conventional method for photographing an ID card or an identification card has a problem in that an imaging device of a scanner scans the identification card for a long time in a scanner manner. In order to solve the problem, a method for photographing an identification card with a camera has been disclosed.

In a method for checking an identification card by photographing as such, the identification card is photographed to acquire image information, and a pre-processing process is performed. Then, the identification card is automatically recognized through a process of searching for a text region in the image information subjected to the pre-processing process, extracting texts that exist in the searched text region to convert the texts into a computer-readable code, and recognizing the code.

Further, in places such as marts, a procedure for checking products using barcodes and checking an identification card in order to sell products, which are not available for purchase by minors, such as alcohol or cigarettes, is required. However, when a manager checks the identification card himself/herself, it is difficult to clearly check a problem such as a forgery, a device for clearly checking the problem is required.

However, since the conventional device may recognize products and identification cards in only one type of barcode or image in one device, it is difficult to check various types of identification card or check the product and the identification card at the same time.

In addition, in order to check various types of identification card or the product and the identification card at the same time, each of a barcode scanner and an image capturing device needs to be separately provided, an installation space thereof is thus widened, resulting in reduction of efficiency of space utilization.

In addition, since each of two devices needs to be used, the user visually confirms the presence or absence of the barcodes and recognizes a recognition target by a corresponding device according to the presence or absence of the barcodes, resulting in reduction of work efficiency.

### RELATED ART DOCUMENT

### Patent Document

(Patent Document 1) KR 1169882 10

### SUMMARY OF THE INVENTION

The present invention is to solve the conventional problems, and an object of the present invention is to provide a multifunctional recognition device and a recognition system using the same, in which the multifunctional recognition device is provided with an image sensor and a barcode scanner, respectively, and simultaneously serves as the image scanner and the barcode scanner in one device without a need to selectively use any device according to a recognition target corresponding to each situation, such that user convenience may be maximized, each information may be stored separately, and the information may be transmitted to the outside.

The objects of the present invention are not limited to those stated above and other objects not stated above may be apparent to those skilled in the art from the following description.

In order to achieve the objects of the present invention, a multifunctional recognition device according to the present invention includes: a housing formed on one side thereof with an opening; a recognition section disposed on an inner side of the housing to face the opening to recognize an image of a recognition target or a barcode provided on one side of the recognition target; an information processing section provided on the inner side of the housing and connected to the recognition section to store and analyze recognition information recognized by the recognition section; a switching section provided on one side of the housing and connected to the information processing section to switch a setting of the recognition section to a barcode recognition mode or an image capture mode; and a communication section configured to transmit the information stored and analyzed by the information processing section to an outside.

The multifunctional recognition section may include an image sensor configured to recognize the recognition target to obtain recognition target digital information and transmit image information of the recognition target to the information processing section, and a lens disposed between the image sensor and the recognition target.

The multifunctional recognition device may further include an inner housing provided between the recognition section and the opening to seal a space between the recognition section and the opening in order to prevent an infiltration of a foreign substance.

The multifunctional recognition device may further include a transparent film provided on the opening of the housing.

The multifunctional recognition device may further include a lighting section provided on the inner side of the housing to irradiate the opening of the housing with light in order to facilitate photographing by the recognition section.

The information processing section may further include an information processing unit configured to analyze the recognition information transmitted from the recognition section, and a storage unit configured to store the recognition information transmitted from the recognition section and analysis information analyzed by the information processing unit.

The information processing section may include a conversion unit configured to convert the recognition information transmitted from the recognition section.

The switching section may include a switch or a button that is exposed to an outside of the housing so that a user is able to selectively change the setting of the recognition section.

The multifunctional recognition device may further include a notification section provided on one side of the housing and connected to the information processing section to aurally or visually transmit an information processing state of the information processing section or a state of error occurrence.

In order to achieve the objects of the present invention in another category, a recognition system using a multifunctional recognition device uses the multifunctional recognition device including the above-described configurations, and the recognition system includes: a recognition step of recognizing the recognition target by the recognition section; a barcode determination step of determining whether barcode information is included in the recognition information recognized by the recognition section; when it is determined that the barcode information is included in the barcode determination step, a barcode reading step of reading the barcode information by the information processing section; and a first external transmission step of transmitting read information, which has been read in the barcode reading step, to an outside, when it is determined that the barcode information is not included in the barcode determination step, the recognition system including: a setting determination step of determining, by the information processing section, whether the switching section changes the setting of the recognition section to an image capture setting; an image capture step of capturing an image of the recognition target by the recognition section when the setting of the recognition section is changed to an image capture method in the setting determination step; and a second external transmission step of transmitting image information, which is captured in the image capture step, to the outside.

The barcode reading step may include a reading confirmation step of confirming whether the barcode information is correctly read.

The information processing section may perform the recognition step to the reading confirmation step again, when the reading is not normally performed in the reading confirmation step.

The recognition system may further include a format conversion step of converting a format of the reading information according to a type and a transmission method of the communication section between the barcode reading step and the first external transmission step.

The recognition system may further include a format conversion step of converting a format of information on the captured image according to a type and a transmission method of the communication section between the barcode reading step and the second external transmission step.

The multifunctional recognition device and the recognition system using the same of the present invention have the following effects.

First, various types of identification card and ID card can be checked regardless of the presence or absence of a barcode in one device, and products including barcodes and the identification cards can be checked according to usage types.

Second, the presence or absence of a barcode is checked in the recognition device, and the identification card or product is recognized through a corresponding process thereof, such that work efficiency can be improved.

Third, the presence or absence of a barcode is automatically determined, such that the user can recognize the barcode himself/herself to the recognition device without visually checking the presence or absence of a barcode of the recognition target, thereby maximizing the work efficiency.

Fourth, because various types of identification card and product can be checked in one device regardless of the presence or absence of a barcode, only one device is installed without installing a plurality of devices for checking various types of recognition target, such that space utilization can be maximized.

Fifth, the recognition device is manufactured in various types according to usage types, such as a box type, a stationary type, and a handgun type, such that usability can be improved.

Sixth, in addition to reading the barcode and storing the image information acquired therefrom by the recognition device itself, the image information can be transmitted to various external devices connected to the recognition device, such that a use effect can be maximized.

Seventh, the recognition device is connected to a central processing center, etc., such that it is possible to quickly check whether or not the user's identification card is forged when the identification card is used in a mart, etc.

Eighth, the power status, operating status, error occurrence, etc. of the multifunctional recognition device are quickly transmitted to the user or the manager through the notification section, such that it is possible to easily check the operation status of the multifunctional recognition device at any time.

The effects of the present invention are not limited to the above-mentioned effects, and other effects not mentioned will be clearly understood by those skilled in the art from the description of the claims.

### BRIEF DESCRIPTION OF THE DRAWINGS

The accompanying drawings attached to the specification illustrate embodiments of the present invention and assist better understanding of the technical aspects of the present invention in conjunction with the detailed description of the present invention. Thus, the present invention should not be construed as being limited only to the matters described in the drawings.

FIG. 1 is a perspective view of a multifunctional recognition device according to the present invention;

FIG. 2 is a configuration diagram schematically showing a configuration of the multifunctional recognition device according to the present invention;

FIG. 3 is a block diagram of the multifunctional recognition device according to the present invention;

FIGS. 4 to 6 are diagrams showing various recognition targets applicable to the multifunctional recognition device according to the present invention; and

FIG. 7 is a flowchart sequentially showing a recognition system using the multifunctional recognition device according to the present invention.

### DETAILED DESCRIPTION OF THE INVENTION

The advantages and features of the present invention and a method of achieving the advantages and features will become more apparent from the embodiments described in detail in conjunction with the accompanying drawings. However, the present invention is not limited to the disclosed embodiments, but may be implemented in various different ways. The embodiments are provided to only complete the present invention and to allow those skilled in the art to fully understand the category of the present invention, and the present invention is defined by the category of the claims.

The term used herein is for the purpose of describing embodiments and is not intended to limit the inventive concept. In the specification, the singular forms include plural forms unless particularly mentioned. The terms “comprises” and/or “comprising” used herein does not exclude presence or addition of one or more other elements, in addition to the above-mentioned elements. The same reference numerals refer to the same elements throughout the specification and “and/or” include each and every combination of one or more of the aforementioned elements. Terms used in the specification, “first”, “second”, etc., are used to describe various components, but the components are not to be limited to the terms. These terms are used only to distinguish one component from another. Therefore, it goes without saying that the first component mentioned below may be the second component within the technical scope of the present invention.

Unless defined otherwise, all terms (including technical and scientific terms) used herein may be used in a sense that is commonly understood by one of ordinary skill in the art to which the present invention belongs. In addition, commonly used predefined terms are not ideally or excessively interpreted unless explicitly defined otherwise.

Hereinafter, the preferred embodiments of the present invention will be described in detail with reference to accompanying drawings.

Configuration of Multifunctional Recognition Device

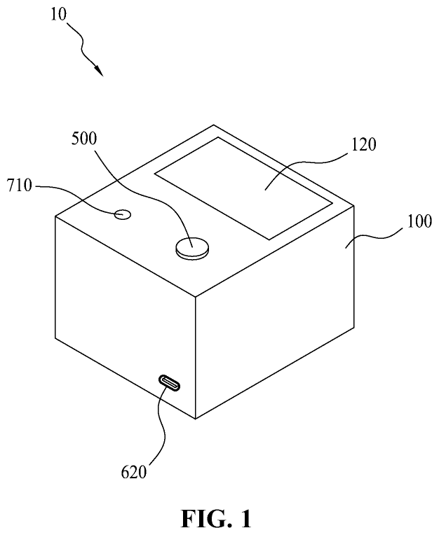

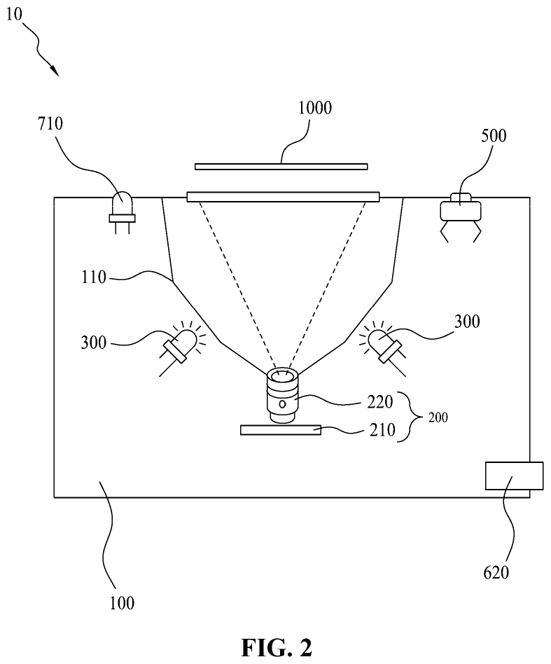

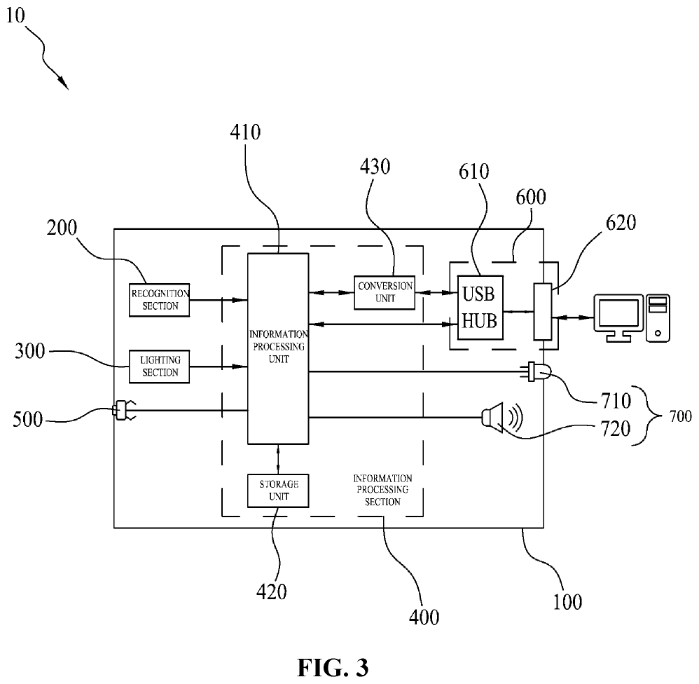

FIG. 1 is a perspective view of a multifunctional recognition device according to the present invention, FIG. 2 is a configuration diagram schematically showing a configuration of the multifunctional recognition device according to the present invention, and FIG. 3 is a block diagram of the multifunctional recognition device according to the present invention. A multifunctional recognition device 10 according to the present invention is a device for acquiring an image of an identification card to check the image using one device or for acquiring a barcode of an ID card or product to acquire information. As shown in FIGS. 1 to 3, the multifunctional recognition device 10 largely includes a housing 100, an inner housing 110, a recognition section 200, an information processing section 400, a lighting section 300, a switching section 500, etc. The housing 100 is a device that forms an exterior of the multifunctional recognition device 10 and provides a space in which each configuration according to the present invention may be seated on inner and outer sides thereof. The housing 100 may be manufactured in various types according to usage types and an installation environment, may stably protect internal configurations from an external shock, etc., and may be formed in any shape as long as the housing 100 may provide use convenience. In one embodiment, the housing 100 may have a hollow hexahedral shape to facilitate mounting as shown in FIG. 1. Although the housing 100 is shown in a hexahedral shape according to one embodiment, this is only for convenience of explanation, the shape of the housing 100 is not limited thereto, and the housing 100 may be manufactured in various types according to the usage types, such as a handgun type. In addition, an opening is formed on one side of the housing 100 so that the recognition section 200, which is provided inside the housing 100, may recognize an identification card or an ID card, or a product outside the housing 100. Such an opening may be freely formed as long as it has a size and a shape that do not interfere with recognition of the recognition section 200.

Further, a transparent film 120 may be provided on one side of the opening of the housing 100 in order to close the opened opening in order to prevent a foreign substance, such as dust, from infiltrating into the housing 100. Here, the transparent film 120 has an area that corresponds to an area of the opening or an area that is relatively larger than the area of the opening, such that the transparent plate may completely close the opening. The transparent film 120 may be formed in various ways, such as a fixed type or an open/close type, in consideration of the usage types and use convenience. The transparent film 120 may be made of any material unless it interferes with the recognition of the recognition section 200, but preferably, may be made of various materials, such as glass, synthetic resin, or acrylic.

The recognition section 200 is a device that is provided on an inner side of the housing 100 to acquire an image of the identification card or to recognize an ID card or a barcode provided on one side of the product. To this end, the recognition section 200 is disposed on the inner side of the housing 100, and preferably, to face the opening of the housing 100. As the recognition section 200, any device may be used as long as it is a device capable of acquiring the image or scanning the barcode. In one embodiment, the recognition section 200 may include an image sensor 210 and a lens 220.

The image sensor 210 is a device that is disposed on the inner side of the housing 100 to face the opening of the housing 100 to acquire an outside image exposed through the opening. The image sensor 210 is a device that shows an image by converting light transmitted through the lens 220 into a digital signal. As such, any device may be used as the image sensor 210 as long as it is a device for recognizing and imaging an external recognition target 100. However, it is preferable that the 2D image sensor 210 may be used. In the present invention, the name of the “image sensor 210” may be used according to one embodiment, but various methods for recognizing the recognition target 1000 may be used. In one embodiment, it is obvious that various devices may be utilized without being limited to the name of the “image sensor 210”, as long as the image sensor 210 is a device capable of recognizing information of the recognition target 1000, such as capturing an image of the recognition target 1000 or sensing the barcode that is marked on one side of the recognition target 1000.

The lens 220 is provided between the image sensor 210 and the housing 100, preferably between the image sensor 210 and the opening of the housing 100, and more preferably on a front of the image sensor 210 in a recognition direction of the image senor in adjacent to the image sensor 210. The lens 220 is a device that collects an external image entering through the opening and transmits the external image to the image sensor 210. As such, any device may be used as the lens 220 as long as it is a device capable of collecting the external image and transmitting the external image to the image sensor 210.

The inner housing 110 is a device that is provided to surround the image sensor 210 and the lens 220 provided in the housing 100, as well as a recognition path of the image sensor 210, to protect the recognition section 200 from an external shock, etc. and to prevent a foreign substance from infiltrating onto the recognition path of the image sensor 210. As such, a shape and a material of the inner housing 110 are not limited as long as an infiltration of a foreign substance may be prevented so that the infiltration of the foreign substance does not interfere with the recognition. However, the inner housing 110 may preferably have a hollow columnar shape, and more preferably have a shape whose diameter is gradually increased from the recognition section 200 toward the opening of the housing 100. In addition, one end of the inner housing 110, which makes contact with the housing 100, may have an area relatively larger than the area of the opening. Further, the inner housing 110 may be made of a translucent material.

As described above, the recognition section 200 and the recognition path are primarily protected through the housing 100, and secondarily protected through the inner housing 110 and the transparent film 120. In particular, because the recognition path is completely closed through the inner housing 110 and the transparent film 120, the recognition target 1000 may be clearly recognized at any time.

The lighting section 300, which irradiates the recognition target 1000 with light so that the recognition section 200 may easily recognize the recognition target 1000, may be further provided on the inner side of the housing 100. As the lighting section 300, any lighting device may be used as long as it is a device capable of irradiating the recognition target 1000 or the recognition path with light to easily recognize the recognition target 1000. However, a lighting device with LED light may be preferably used. The lighting device may directly irradiate the recognition target 1000 with light or directly irradiate one side of the recognition path with light, but may preferably irradiate the inner housing 110 made of a translucent material with light and irradiate the recognition path with light having a predetermined illuminance through an indirect lighting effect.

Here, an illumination sensor, which measures an illuminance according to a surrounding environment to automatically control an operation of the lighting section 300 and a lighting brightness of the lighting section 300, may be provided on at least one of an inner or outer side of the housing 100 and one side of the inner housing 110 and connected to the information processing section 400.

Moreover, a detection sensor, which recognizes approach of the recognition target 1000 to transmit approach information to the recognition section 200 and starts to operate the recognition section 200, may be further provided on the outer side of the housing 100 and connected to the recognition section 200 or the information processing section 400. When the detection sensor is provided, the recognition section 200 may acquire recognition information according to a signal of the detection sensor. When the detection sensor is not provided, the recognition section 200 may perform a recognition operation in a predetermined cycle according to a previously input program. An operating state of the recognition section 200 is set in various ways according to the usage types, and a method of setting the operating state of the recognition section 200 is not limited thereto.

The information processing section 400 is a device that stores and analyzes an image of the recognition target 1000, which is recognized by the recognition section 200, and simultaneously, generally controls the multifunctional recognition device 10. The information processing section 400 may have any configuration or may be any device as long as it is a device capable of storing and analyzing the image or barcode information transmitted from the recognition section 200. In one embodiment, the information processing section 400 may include an information processing unit 410 that processes information on the recognition section 200, a storage unit 420 that stores the information on the recognition section 200, and a conversion unit 430 that converts the information on the recognition section 200. The respective units will be described in more detail as follows.

The information processing unit 410 is a device that is configured to be electrically connected to various components constituting the multifunctional recognition device 10 according to the present invention to control each configuration, and simultaneously, to analyze the information on the image or barcode recognized by the recognition section 200. Any device may be used as the information processing unit 410 as long as it may perform such functions, but preferably, an information processing device in which a program for the analysis and control is previously input, such as a central processing unit (CPU), may be used. Here, the information processing unit 410 processes both of image information and barcode analysis information, but may be configured to transmit the image information and barcode analysis information using different ports when transmitting to the outside.

The storage unit 420 is a device that is provided to be connected to at least one of the recognition section 200 and the information processing unit 410 to store the recognition information recognized by the recognition section 200 and the analysis information which has completed the analysis by the information processing unit 410. As the storage unit 420, any device may be used as long as it is a device capable of storing predetermined data. Preferably, a data memory may be used.

The conversion unit 430 is a device that is provided to be connected to at least one of the recognition section 200, the information processing unit 410, and the storage unit 420 to convert the information transmitted from each device into various formats according to the usage types. The conversion unit 430 may change the format according to the usage types of each data. For example, the information transmitted from the above-described device may be changed to a USB format.

The switching section 500 is a device that is provided to be connected to the information processing unit 410 to convert a setting for whether the recognition section 200 photographs the image of the recognition target 1000 or whether the recognition section 200 recognizes the barcode of the recognition target 1000. The switching section 500 may automatically change the setting of the recognition section 200 according to an information processing result of the information processing unit 410 or may change a recognition setting of the recognition section 200 by a user depending on a selection of the user. Here, when the user changes the setting of the recognition section 200 himself/herself, the switching section 500 may be electrically connected to the information processing unit 410 and include a switch or a button partially exposed to the outside of the housing 100. When the switching section 500 is composed of the switch or the button as such, the user changes the recognition setting of the recognition section 200 as the user operates the switching section 500. As for an operation standard of the switching section 500, the user may visually grasp the presence or absence of the barcode of the recognition target 1000, or the recognition section 200 may determine the presence or absence of the barcode by the information processing section 400 based on the recognition information, which is primarily recognized by the recognition section 200, to notify the user of the presence or absence of the barcode and grasp the presence or absence of the barcode by the user.

The communication section 600 is a device that is connected to the information processing section 400 and transmits information supplied from at least one of the recognition section 200, the information processing unit 410, and the storage section 420 to the outside. As the communication section 600, any device may be used as long as it is a device in communication with at least one of wired and wireless methods according to the usage types. In one embodiment, the communication section 600 may include a USB port 620, which is provided on one side of the housing 100 and connected to the information processing section 400, or may include a wireless communication unit which wirelessly transmits and receives information using a communication network. Obviously, the communication section 600 may include both of the USB port 620 and the wireless communication unit according to the usage types.

The multifunctional recognition device 10 having the above-described configuration may further include a notification section 700 for aurally or visually transmitting a current state, an operating state, etc. to a user or a manager. As the notification section 700, any device may be used as long as it is a device capable of quickly transmitting the current state, the operating state, and the state of error occurrence of the multifunctional recognition device 10. In one embodiment, the notification section 700 may include a speaker 720 and an indicating lamp 710. Here, the speaker 720 refers to any device that generates various voices or electronic sounds, and the indicating lamp 710 refers to any device that is notified through various colors or flickering, but preferably, an LED indicating lamp may be used.

Method for Recognizing Recognition System Using Multifunctional Recognition Device

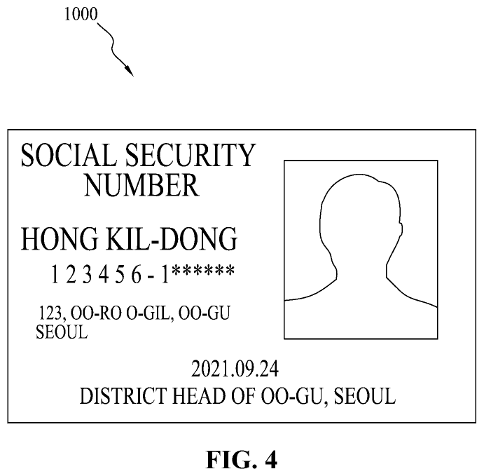

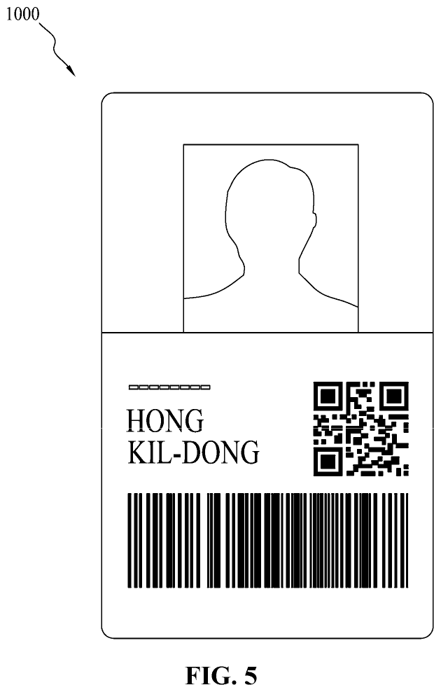

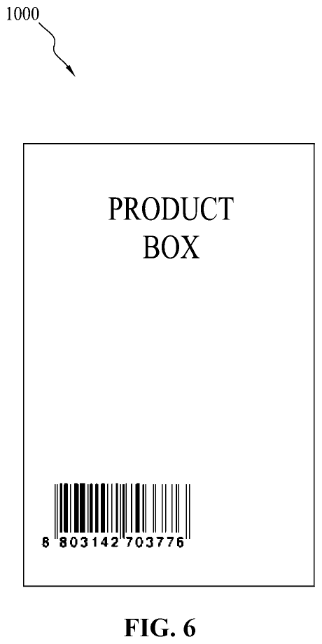

FIGS. 4 to 6 are diagrams showing various recognition targets applicable to the multifunctional recognition device according to the present invention. The multifunctional recognition device 10 according to the present invention may check a general identification card shown in FIG. 4, such as a social security number card and a driver's license, or an ID card used in various situations, as shown in FIG. 5. Furthermore, in a market etc. according to the usage types, a barcode of a product as shown in FIG. 6 may be recognized, and at the same time, an identification card for sale of alcohol, cigarettes, etc. may be checked using one device.

The recognition section 200 of the multifunctional recognition device 10 sets various basic settings according to the usage types, but in the present invention, the description will be based on the multifunctional recognition device 10 with barcode recognition and reading as basic settings. Obviously, the recognition section 200 may set image capture as a basic setting according to the usage types.

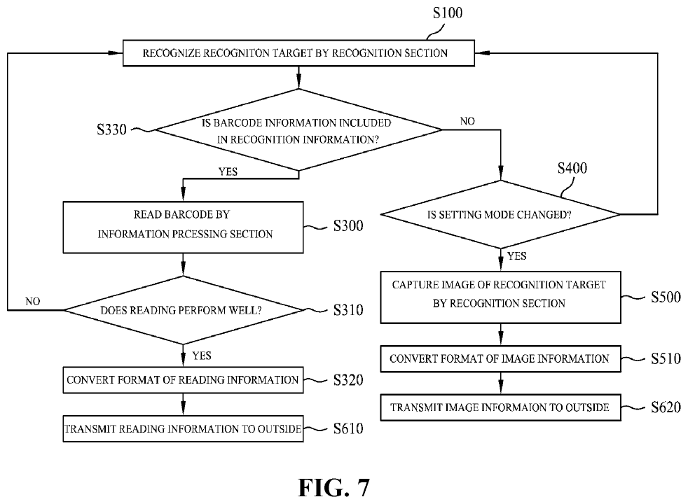

FIG. 7 is a flowchart sequentially showing a recognition system using the multifunctional recognition device according to the present invention. A recognition system, which recognizes the recognition target 1000 using the multifunctional recognition device 10 having the above-described configuration and reads the recognition information, will be described in more detail with reference to FIG. 7 as follows.

First, when power is supplied through the USB port 620 of the communication section 600 or a separate power supply device, the multifunctional recognition device 10 starts to operate, and the notification section 700 notifies the user or the manager of power-on of the multifunctional recognition device 10. For example, the speaker 720 of the notification section 700 generates a beep sound once for a long time, and the indicating lamp 710 turns on red light for one second, and then turns on green light for one second.

Next, when the recognition target 1000, such as an identification card without a barcode, an ID card with a barcode, or a product with a barcode, is disposed on the opening of a body of the multifunctional recognition device 10, the recognition section 200 recognizes the recognition target 1000 (S100). Here, recognition of the recognition section 200 is performed in various ways according to the presence or absence of the detection sensor, and an operation of the recognition section 200 is thus controlled. When the detection sensor is provided on one side of the housing 100 to recognize the approach of the recognition target 1000, the recognition section 200 may start to operate according to a sensing signal of the detection sensor. As other usage types, when the detection sensor is not provided, the recognition section 200 may operate in a predetermined cycle according to a program that is previously input to the information processing section 400. For example, the recognition section 200 may operate in a cycle of one second, and the lighting section 300 also operates at a time corresponding thereto. The recognition section 200 may initially operate in a manner similar to a barcode extraction method of a general barcode scanning device, the detailed description thereof will be thus omitted.

Next, it is determined whether or not the barcode is detected on the recognition target 1000 based on the recognition information acquired by scanning the recognition target 1000 by the recognition section 200 (S200). That is, when the recognition target 1000 is the ID card or product with a barcode formed thereon, the barcode may be extracted from the recognition section 200, but when the recognition target 1000 is a social security number card, driver's license without a barcode, the barcode may not be extracted from the recognition section 200 because there is no barcode. Here, the information processing section 400 may immediately determine the presence or absence of the barcode acquired from the recognition section 200 according to the usage types, or store the recognition information acquired from the recognition section 200 and determine the presence or absence of the barcode by using the stored recognition information. Such a barcode reading method can be performed in various ways according to settings.

In the following process, the subsequent process is performed differently depending on whether the recognition unit 200 extracts the barcode as a recognition result of recognition target 1000. The subsequent process will be described in more detail according to each situation as follows.

[Case where Barcode is Detected on Recognition Target]

When the barcode is detected in the barcode determination step (S200), the information processing section 400 reads the barcode based on the recognition information recognized by the recognition section 200 (S300). Here, the information processing section 400 sets the multifunctional recognition device 10 in an optimized state for barcode reading, such as improving a lighting cycle of the lighting section 300 for smooth reading of the barcode.

Next, the information processing unit 410 of the information processing section 400 confirms whether or not the barcode reading is normally performed (S310). Even if the recognition section 200 performs recognition, extraction, and reading of the barcode, the information processing unit 410 confirms whether the reading is normally performed because the barcode is not clearly read due to a surrounding environment, a poor state of the barcode, etc. When the reading is abnormally performed in the reading confirmation step (S310), the notification section 700 notifies the outside of such a situation of error occurrence, and the information processing section 400 performs again the recognition step (S100) of recognizing the recognition target 1000 by the recognition section 200 to the reading confirmation step (S310).

Next, when it is determined that the barcode reading is normally completed in the reading confirmation step (S310), reading information is transmitted to the outside through the communication section 600 (S610). Although the present invention has been mainly described for external transmission through the USB port 620 via the USB hub 610, the reading information may be transmitted to the outside in various ways according to the usage types. That is, the communication section 600 may be configured in various ways, such as the USB port 620 for wired transmission or a wireless communication device for wireless transmission. Although the present invention has been mainly described for an external device, such as a host PC that is connected by a wire through the USB port 620, this is merely an example, and the external device to which the information is transmitted may transmit information to various external devices set by the user, such as a portable terminal, an external server, and a central processing unit.

In addition, in order to change the reading information before the external transmission (S610) to a format desired by the user, the format may be changed by the conversion section (S320). In one embodiment, the reading information, which has been read in the reading step (S300), may be transmitted through a universal asynchronous receiver transmitter (UART) port, and the reading information may be changed to a USB format by the conversion unit 430. The conversion step (S320) is not essential, methods.

[Case where Barcode is not Detected on Recognition Target]

When the barcode is not recognized on the recognition target 1000 in the barcode determination step (S200), the information processing section 400 determines whether a setting mode is changed (S400). The setting mode may be automatically changed by the information processing section 400 based on the preset program, or may be changed the setting by the user himself/herself through the switching section 500 provided on an outer side of the housing 100, such as a button or a switch. Here, since the present invention has been mainly described for the recognition section 200 having barcode recognition as a basic setting, it is preferable that the setting of the recognition section 200 is automatically changed to a barcode recognition mode when a predetermined time elapses after the setting of the recognition section 200 is changed in the image capture method. Obviously, the image capture mode may be maintained when the user does not change the setting through the switching section 500 according to the usage types.

Next, when it is determined that the setting of the recognition section 200 has been changed to the image capture mode in the setting determination step (S400), the recognition section 200 captures an image of the recognition target 1000. Here, the information processing section 400 operates in a state in which an operation, brightness, operating time, etc. of the lighting section 300 are optimized for image capture. In the operating state of the lighting section 300, the lighting section 300 may operate based on information collected through an illuminance sensor. Here, the lighting section 300 irradiates the inner housing 100 made of a translucent material with light such as indirect lighting, such that it is possible to minimize reflection light generated from the recognition target 1000, and accordingly, it is possible to acquire a clearer image. In addition, the image captured by the recognition section 200 is stored in the storage unit 420 of the information processing section 400.

Next, the image captured by the recognition section 200 is transmitted to the outside (S620). Although the present invention has been mainly described for transmission of information on the captured image to the outside through the USB port 620, the information may be transmitted to the outside in various ways according to the usage types. That is, the communication section 600 may be configured in various ways, such as the USB port 620 for wired transmission or a wireless communication device for wireless transmission.

In addition, the information processing unit 410 may convert a format of the image information according to the usage types before transmitting the information on the captured image to the outside (S620) or storing the information on the captured image in the storage unit (420), or may perform conversion to reduce a capacity of the image information through a size change or compression (S510). For example, in order to reduce a transmission speed and reduce a storage capacity according to the usage aspects, at least one of original image data and the converted data may be stored in the storage unit 420 or transmitted to the outside by converting the captured image information into a joint photographic experts group (JPEG) or a portable network graphics (PNG) format.

Although the above-described process has been mainly described for acquiring an image of the recognition target 1000 without a barcode, it is obvious that the image of the recognition target 1000 with a barcode may also be acquired according to the usage types.

All data acquired through the above-described process, that is, the recognition information, barcode decoding information, captured image information, etc. are stored in a memory unit, and then transmitted to the outside through the communication section 600 or directly transmitted to the outside through the communication section 600. This setting may also be used in various ways according to a program that is previously input to the information processing section 400 in accordance with various usage types.

In addition, since the barcode reading information and image capture information are transmitted to the USB hub 610 through each individual port, and the USB hub 610 is connected to the external device through only one connection line because information is transmitted to the outside through one USB port 620, the information read by one multifunctional recognition device 10 may be recognized by the external device, such as a host PC, as the barcode reading and the image capture performed by a separate device. That is, one multifunction recognition device 10 performs barcode recognition and image capture, but the external device recognizes that the barcode recognition and the image capture are performed individually by two devices.

As described above, those skilled in the art to which the present invention pertains will understand that the present invention may be implemented in various detailed forms without changing the technical spirit or indispensable features of the present invention. It should be understood that the above-described embodiments are illustrative and not limitative in all aspects. The scope of the present invention is defined by the appended claims rather than the detailed description, and the present invention should be construed to cover all modifications or variations induced from the meaning and scope of the appended claims and their equivalents.

What is claimed is:

1. A multifunctional recognition device comprising:
a housing formed on one side thereof with an opening;
a recognition section disposed on an inner side of the housing to face the opening to recognize an image of a recognition target or a barcode provided on recognition target one side of the recognition target;
an information processing section provided on the inner side of the housing and connected to the recognition section to store and analyze recognition information recognized by the recognition section;
a switching section provided on one side of the housing and connected to the information processing section to change a setting of the recognition section to a barcode recognition mode or an image capture mode; and
a communication section configured to transmit the information stored and analyzed by the information processing section to an outside.

2. The multifunctional recognition device of claim 1, wherein the recognition section includes:
an image sensor configured to recognize the recognition target to obtain recognition target digital information and transmit image information of the recognition target to the information processing section; and
a lens disposed between the image sensor and the recognition target.

3. The multifunctional recognition device of claim 1, further comprising an inner housing provided between the recognition section and the opening to seal a space between the recognition section and the opening in order to prevent an infiltration of a foreign substance.

4. The multifunctional recognition device of claim 1, further comprising a transparent film provided on the opening of the housing.

5. The multifunctional recognition device of claim 1, further comprising a lighting section provided on the inner side of the housing to irradiate the opening of the housing with light in order to facilitate photographing by the recognition section.

6. The multifunctional recognition device of claim 1, wherein the information processing section includes:
an information processing unit configured to analyze the recognition information transmitted from the recognition section; and
a storage unit configured to store the recognition information transmitted from the recognition section and analysis information analyzed by the information processing unit.

7. The multifunctional recognition device of claim 1, wherein the information processing section includes a conversion unit configured to convert the recognition information transmitted from the recognition section.

8. The multifunctional recognition device of claim 1, wherein the switching section includes a switch or a button that is exposed to an outside of the housing so that a user is able to selectively change the setting of the recognition section.

9. The multifunctional recognition device of claim 1, further comprising a notification section provided on one side of the housing and connected to the information processing section to aurally or visually transmit an information processing state of the information processing section or a state of an error occurrence.

10. A recognition system using the multifunctional recognition device of claim 1, the recognition system comprising:
a recognition step of recognizing the recognition target by the recognition section;
a barcode determination step of determining whether barcode information is included in the recognition information recognized by the recognition section;
when it is determined that the barcode information is included in the barcode determination step,
a barcode reading step of reading the barcode information by the information processing section; and
a first external transmission step of transmitting read information, which has been read in the barcode reading step, to an outside,
when it is determined that the barcode information is not included in the barcode determination step,
a setting determination step of determining, by the information processing section, whether the switching section changes the setting of the recognition section to an image capture setting;
an image capture step of capturing an image of the recognition target by the recognition section when the setting of the recognition section is changed to an image capture method in the setting determination step; and
a second external transmission step of transmitting image information, which is captured in the image capture step, to the outside.

11. The recognition system of claim 10, wherein the barcode reading step includes a reading confirmation step of confirming whether the barcode information is correctly read.

12. The recognition system of claim 11, wherein the information processing section performs the recognition step to the reading confirmation step again, when the reading is not normally performed in the reading confirmation step.

13. The recognition system of claim 10, further comprising a format conversion step of converting a format of the reading information according to a type and a transmission method of the communication section between the barcode reading step and the first external transmission step.

14. The recognition system of claim 10, further comprising a format conversion step of converting a format of information on the captured image according to a type and a transmission method of the communication section between the barcode reading step and the second external transmission step.
